(19) United States
(12) Patent Application Publication
(10) Pub. No.: US 2022/0034553 A1
(43) Pub. Date: Feb. 3, 2022

(54) Ice Room

(71) Applicant: Sasi K. Lekkala, Irving, TX (US)

(72) Inventor: Sasi K. Lekkala, Irving, TX (US)

(21) Appl. No.: 16/945,859

(22) Filed: Aug. 1, 2020

(51) Int. Cl. F24T 50/00; F25C 1/02; F25D 1/02; F25D 23/06; F25D 31/00

(52) U.S. Cl. CPC F24T 50/00; F25C 1/02; F25D 31/00; F25D 23/065; F25D 1/02

(57) ABSTRACT

A multilayered wall with combinations of resistant layers with a layer that can be cooled with a Direct Current (DC) compressor and/or a layer that exchanges energy with a geo thermal source to cool an area like a mailbox or a guard house or an ice chest.

### SUMMARY

The changes in technology will allow for building an ice room. Ice room meaning a cooler area for a guard house, mail box, a mobile unit and/or an ice storage unit.

A multilayered wall to form a box. The wall will have layers of vacuum and/or other insulation material combined with another layer that exchanges heat with a geo thermal source or a coolant layer that can be cooled with a Direct Current (DC) compressor. The changes in technology will allow for this to happen with or without a general purpose alternating current supply. The device with a solar panel or other renewable source of energy can run the minimal power needs of the device in conjunction with a battery. The geo thermal source will also stabilize the area not to get too cold or too hot for a general-purpose use. If there is any excess energy can be used to make ice that can be used for later use. The device will need other peripherals to make this happen like thermal sensors, wires and/or switches that would be used typically in refrigeration and/or geothermal heat exchangers.

The box or this cooling area can be used for any purpose that needs thermal heat control.

1. Usage of stored ice for cooling an area

2. Multi layered walls to make a container to keep area cool and/or store ice. Walls will have a layer or layers supported by geo thermal heat transfer

3. Multi layered walls to make a container to keep area cool and/or store ice. Walls will encompass a layer or layers that cool and/or heat depending on the need and can be supported by renewal sources of energy

4. claims 2 and 3 combined to make a container

5. claims 2 and/or 3 used for the purpose of cooling or stabilizing the temperature of a mailbox.

6. Claims 2 and/or 3 used for the purpose of cooling a small area used for storage or living.

7. Claim 1 to be made from renewable energy source and the ice used for the purpose of cooling an area.

8. Claims 2 and/or 3 used for the purpose of cooling or stabilizing the temperature of a guard house or an area suitable for a human or storing goods.

9. Claims 2 and/or 3 used for the purpose of cooling or stabilizing the temperature of a mobile unit.

10. Permanent installations of geo thermal loops pluggable into to support claim number 2.

11. A container built into the earths mantel layer to support the function of claim 1

12. claim 1, 2 and/or 3 to be used to stabilize and/or maintain the temperature of an area

13. claim 1, 2 and/or 3 to be used to assist with other technologies to maintain the temperature of an area

14. Any of the above claims to build a structure-like body of an automobile, ship or spaceship or a wall
